(19) United States
(12) Patent Application Publication
(10) Pub. No.: US 2009/0164644 A1
(43) Pub. Date: Jun. 25, 2009

(54) WIRELESS SECURITY CONFIGURATION SYSTEM AND METHOD

(76) Inventors: Ulf Soderberg, Taby (SE); John Wu, San Diego, CA (US); Cuong Pham, Seattle, WA (US)

Correspondence Address: FOLEY & LARDNER LLP, P.O. BOX 80278, SAN DIEGO, CA, 92138-0278, US

(21) Appl. No.: 11/959,789

(22) Filed: Dec. 19, 2007

(51) Int. Cl. G06F 15/16

(52) U.S. Cl. 709/228

(57) ABSTRACT

A wireless network security method comprises a first communications device generating configuration settings for wireless access and transferring that information to a second communications device through a removable storage device or directly through a physical electrical interface.

### BACKGROUND OF THE INVENTION

The present invention relates generally to the field of wireless routers, and more particularly to the area of wireless router security.

Currently, the use of wireless routers requires security measures on both the user's personal computer (PC) and the wireless network in order to gain access to that network. A Wired Equivalent Privacy or Wireless Encryption Protocol (WEP, WEP2, WEPPlus) key, currently part of the IEEE 802.11 standard, or a WiFi Protected Access (WPA(2)), currently part of the IEEE 802.11i standard is required for access to the router. As well, the user must then manually configure their PC in order to coincide with the same security settings of the router. This often requires a lengthy hexadecimal key. With multiple steps required on both devices, error will frequently occur. As well, many users are unfamiliar with the requirements and usage of these settings, causing additional support to be necessary.

Basic systems require that a user first establish a connection between a wireless router to the PC and then a connection from the router to the internet. With routers such as Linksys, the router must be powered on and then it appears on the user's PC wireless access point (AP). Then, the user must hardwire the router to the PC in order to be configured. When the router is connected to the PC and the PC is connected to the internet, the user is required to visit a website address indicated by the router's documentation. The user is prompted to enter an administrative password, also provided by the router's documentation. The router can then be configured to the desired security settings. The user can choose the desired settings for the router, such as the name of the AP, the network type, and the security. The security settings can be automatically generated, but the user must record the initial administrative password to enter the configuration site and one of the generated keys to access the router from the PC or another device.

After configuring the router, the user must then configure their computer to read the router settings. The user will be prompted to provide a security key for the router and is still required to go through a series of steps (set-up wizard) to configure the security settings of their PC. This often lengthy process, includes many steps and is not even highest level security for the wireless connection it provides. WPA systems are better encrypted, but require additional key and initialization vector size.

The aforementioned system can employ the currently available JumpStart security enabler over the WPA secure settings. However, the JumpStart system requires each new user enter the key/password in order to use the network. Often, these passwords are misplaced, and the entire system must be reconfigured, resulting in another required set-up by the user.

Further, the SecureEasy by Broadcom requires that the system security requirements be reset if a new user enters the network. Every time the system has to generate a new key due to new users, the system is subject to pirating.

### SUMMARY OF THE INVENTION

One aspect of the present invention relates to a wireless network security method comprising receiving information by a storage device about configuration settings from a first communication device on a storage device and transferring the information to a second communication device.

In one embodiment, the receiving includes establishing a connection between the storage device and the first communication device wherein the first communication device stores configuration settings on the storage device.

In one embodiment, the connection between the first communication device and the storage device is terminated, after the storage device receives the configuration settings from the first communication device.

In another embodiment, a connection between a second communication device and the storage device is established, and the storage device transfers the configuration settings onto the second communication device.

In yet another embodiment, a secure wireless network connection is made between the first communication device and the second communication device using the configuration settings received and transferred by the storage device.

In one embodiment, the receiving and transferring of configuration settings is made through a USB interface, a Bluetooth interface, a 3G DO interface or an IEEE 802.11 interface.

In another aspect, the invention relates to a storage device with an interface for transferring data to or from a communication device. In addition, the storage device contains a module for storing configuration settings generated by a first communication device and adapted for transferring configuration settings to a second communication device.

In one embodiment, the device module automatically sets the configurations on the second communication device.

In a further embodiment, the device module contains an auto run program for setting the configurations on the second communication device.

In one embodiment, the configuration settings are generated from the first communication device and transferred to a second communication device in order to establish a secure wireless network connection.

In another embodiment, the device interface is a USB dongle.

In another embodiment, the first communication device is wireless router and the second communication device is a PC.

Another aspect of the invention relates to a system for transferring wireless network security data between a first communication device and a second communication device through the use of a removable storage device.

In one embodiment, the system is utilized to establish a secure wireless network connection between the first and second communication devices. In a further embodiment, the first communication device is a wireless router and the second communication device is a computing device.

In another embodiment, the first communication device is a wireless router and the second communication device is a computing device.

### BRIEF DESCRIPTION OF THE DRAWINGS

FIG. 1 shows an exemplary computing device, removable storage device and wireless router in a system according to an embodiment of the present invention.

FIG. 2 shows a flow chart of a wireless communication method according to one embodiment of the present invention.

FIG. 3 shows a flow chart of a wireless communication method according to another embodiment of the present invention.

FIG. 4 shows an exemplary computing device and routing device in a system according to an embodiment of the present invention.

### DETAILED DESCRIPTION OF THE PREFERRED EMBODIMENTS

Embodiments of the present invention provide an improved method, system and device for establishing a secured wireless connection simplifying the configuration setup process, while providing a secure network configuration.

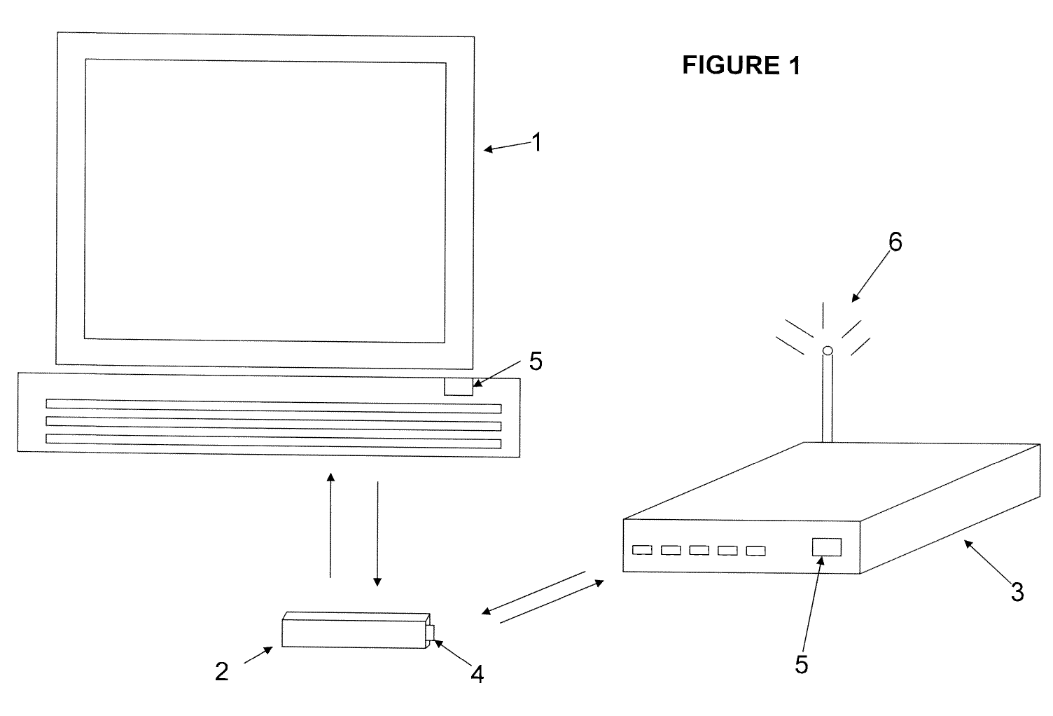

FIG. 1 illustrates an embodiment of a wireless communication system including a first communication device 1 and a second communication device 3. The first and second communication devices 1, 3 are able to communicate in a secure wireless manner. The first communication device 1 may be configured to wirelessly access the second device 3, the configuration of the first device being achieved through the use of a storage device 2.

The first communication device 1 may be one of any number of types of communication devices, such as a desktop, a laptop, a personal digital assistant (PDA) or any other such communication device. The second communication device 3 may also be one of any number of devices. In a particular embodiment, the second communication device 3 is a wireless router which provides secure wireless access to a network to one or more devices.

In one embodiment, the storage device 2 is removable, and can have a USB interface 4 for connection to a USB port 5 on the second communication device 3 (such as a wireless router) and/or the first communication device 1 (such as a personal computer (PC)). In a further embodiment, the storage device 2 can be a USB dongle, and the second communication device 3, can be a wireless router. In other embodiments, the storage device 2 may be adapted to communicate with the first and/or second communication devices 1, 3 through other interfaces, including wireless interfaces such as Bluetooth. In this regard, the storage device 2 may be adapted to send or receive information to or from a communication device via the Bluetooth protocol. Thus, a connection between the storage device and the communication devices may not require a physical connection.

The secured wireless communication can be established between the first communication device 1 and the second communication device 3 by first forming a connection between the storage device 2 and the second communication device 3, wherein second communication device 3 transfers configuration settings onto the storage device 2. Thus, configuration settings, which may include a password, key or other information, may be generated by the second communication device 3 and transferred to the storage device. As noted above, this transfer may be achieved either through a USB interface, a Bluetooth interface or other appropriate interface. The configuration settings may then be transferred from the storage device 2 to the first communication device 1, which may include a wireless modem and software to configure the wireless modem to enable wireless communication with the second communication device 3.

The secured wireless connection established between the first communication device 1 and the second communication device 3 may allow communication through a variety of protocols, such as IEEE 802.11, 3G DO, or the like.

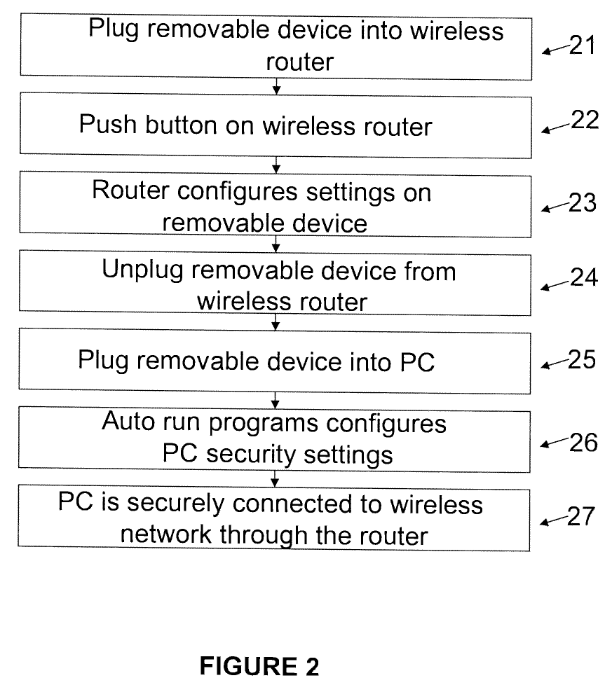

FIG. 2 provides a flow diagram of an embodiment of the present invention for transfer of information associated with configuration settings from a device, such as a wireless router, to a storage device. In the illustrated embodiment, the data transfer occurs when the storage device is first plugged into a communication device (block 21). In one embodiment, the communication device can be a wireless router or similar device, and the connection can be established by a USB interface. The communication device may be provided with software adapted to recognize the connection of the storage device or, in one embodiment, may be provided with a button or a switch to initiate the transfer of data. When the user pushes the button on the communication device (block 22), the configuration settings are generated by the communication device and transferred for storage onto the storage device (block 23).

The storage device may be a removable device, such as a USB dongle. In other embodiments, the storage device may be adapted to wirelessly connect with the communication device, for example, through a Bluetooth session. Next, the user unplugs or otherwise disconnects the storage device from the communication device with the information corresponding to configuration settings being stored on the storage device (block 24).

The user can then take the storage device and connect it to a second communication device, such as a PC, laptop, PDA, or the like (block 25). Once the storage device is plugged into or otherwise connected to the second communication device, a module located within the second communication device can begin configuration of the second communication device to enable wireless communication. In one embodiment, this module can be an auto run program that automatically configures the security settings on the second communication device (block 26). With the configuration completed, the second communication device, such as a PC, and the first communication device, such as a wireless router, may be securely connected for wireless communication (block 27). The second communication device may then be provided wireless access to a network through the first communication device. In this regard, the network may be of the type including a public network, such as the Internet.

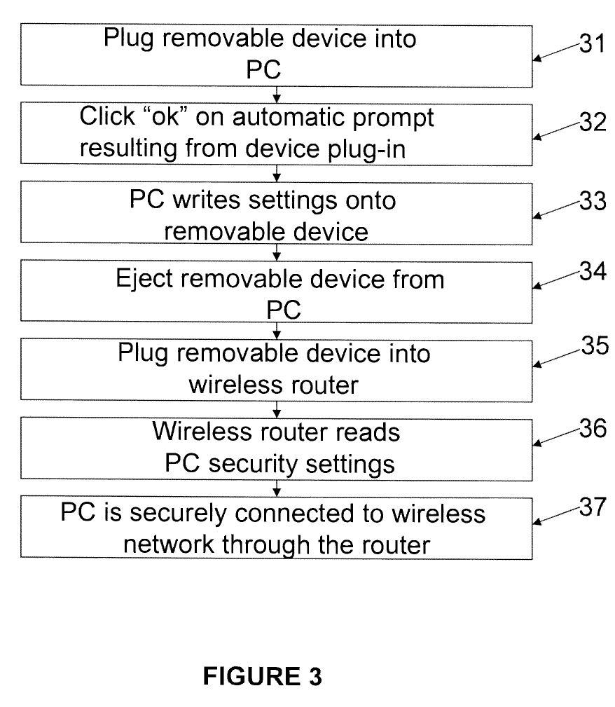

FIG. 3 provides a flow diagram of an alternative embodiment of the present invention. In the embodiment of FIG. 3, the data transfer occurs in a different direction from the embodiment described above with reference to FIG. 2. In the embodiment of FIG. 3, the storage device is connected to a first communication device, such as a PC or a similar type of computing device (block 31). In one embodiment, after establishing a connection between the first communication device and storage device, an automatic prompt may appear on the first communication device. From the prompt, the user may initiate the data transfer of the configuration settings onto the storage device (block 32). In this regard, the configuration settings may include information specifically identifying the first communication device and may include information to enable identification and authentication of the first communication device. The first communication device then writes the configuration settings onto the storage device (block 33). In further embodiments, the storage device can automatically receive the data transfer without a prompt. As well, there can also be a button or switch located on the storage device that can be pushed in order to initiate the data transfer of the configuration settings.

Next, the user removes the storage device from the first communication device in order to transfer the configuration settings to another, secondary communication device, such as a router, wireless router, or even another computing device (block 34). The user then establishes a connection between the storage device and the second communication device in order to transfer the configuration setting data stored on the storage device (block 35). The second communication device can then read the configuration settings from the first communication device (block 36) in order to establish a secure wireless connection with the first communication device (block 37), allowing the first communication device wireless access to a network through the second communication device.

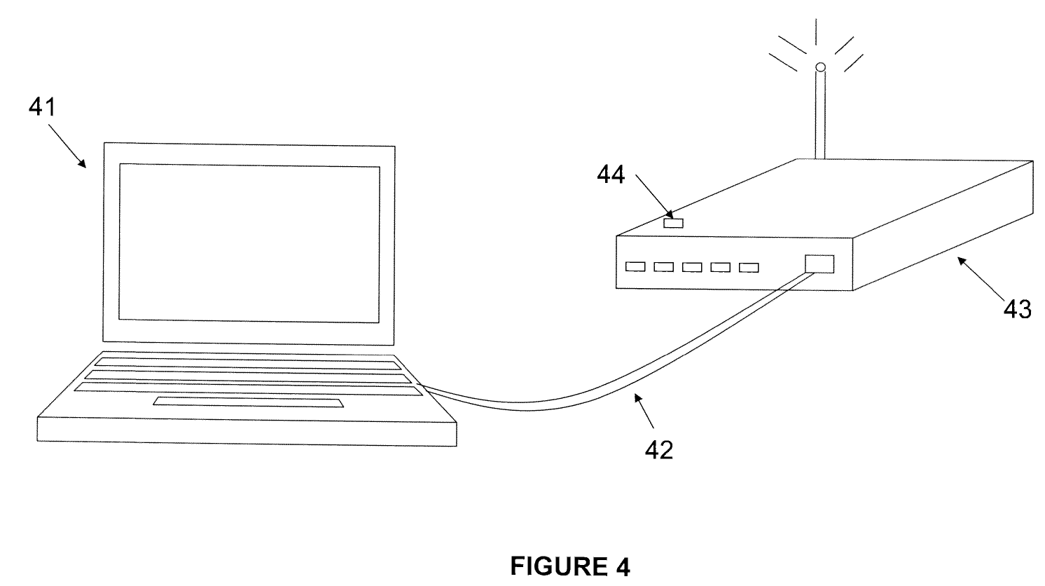

FIG. 4 provides another embodiment of the present invention for transfer of configuration settings from the routing device to the computing device. In this embodiment, a first communication device 43, such as a wireless routing device, may have the ability to configure the wireless settings on the second communication device 41, such as a PC or a similar type of computing device. The user may link the two communication devices 41, 43 through an Ethernet, USB or similar interface 42 in order to establish a connection. The user may then push a button 44 on the first communication device 43 to generate the settings and then configure them on the second communication device 41. When these settings are generated on the first communication device 43, or wireless router, the second communication device 41 is triggered to receive the configuration settings. The second communication device 41 then configures according to the received settings, and the two devices may then be disconnected from one another. The two devices may then establish a secure wireless connection with the transferred configuration settings.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A wireless network security method comprising:
receiving information by a storage device from a first communication device, the information being associated with configuration settings for access by a second communication device; and
transferring the information from the storage device to the second communication device.

2. The method of claim 1, wherein the receiving comprises:
establishing a connection between the first communication device and the storage device;
wherein the first communication device stores configuration settings on the storage device.

3. A method of claim 2 where the transfer to the storage device from the first communications device happens when a button is pushed on the first communications device or when the interface is first established.

4. The method of claim 2, wherein the receiving further comprises:
terminating the connection between the first communication device and the storage device.

5. The method of claim 1, wherein the transferring comprises establishing a connection between the storage device and the second communication device;
wherein the storage device transfers configuration settings to the second communication device.

6. The method of claim 5 where the transfer to the second communications device happens when a button is pushed on the second communications device or when the interface is first established between the storage device and the second communications device.

7. The method of claim 1, further comprising establishing a secure wireless connection between the first and second communication device using the configuration settings.

8. The method of claim 1, wherein the receiving and/or transferring uses a USB interface.

9. The method of claim 1 where the receiving and/or transferring uses a standard physical electrical interface.

10. The method of claim 1, wherein the receiving and/or transferring uses a standard wireless interface.

11. The method of claim 7, wherein the wireless interface is a Bluetooth interface.

12. The method of claim 7, wherein the wireless interface is a IEEE 802.11 interface.

13. The method of claim 7, wherein the wireless interface is a 3G DO interface.

14. A wireless network security method comprising:
transferring information from a first communication device to a second communication device, the information being associated with configuration settings for access by the second communication device; and
receiving the information from the first communication device;
configuring the settings on the second communication device; and
establishing a secure wireless connection between the first communication and second communication device.

15. The method of claim 14 where the receiving and/or transferring uses a standard physical electrical interface.

16. The system of claim 14 wherein the first communication device is a wireless routing device.

17. The system of claim 14 wherein the second communication device is a computing device.

18. A wireless communications device comprising:
the ability to generate a configuration settings and an interface for transferring data to or from another wireless communications device; the interface being adapted to transfer configuration settings to a second communication device for establishing wireless access to the second wireless communications device.

19. The device of claim 18 wherein the wireless communications device automatically generates the settings and sets the configurations on the second communication device when the interface is established.

20. The device of claim 18 wherein the wireless communications device sets the configurations on the second communication device when a button is pushed on the first device.

21. The device of claim 18 wherein the settings are generated and configured in order to establish a secure wireless connection between the first and second communication devices.

22. The device of claim 18 wherein the interface is a physical electrical interface or a wireless interface.

23. The device of claim 18 wherein the second communication device is a computer.

24. The device of claim 18 wherein the first communication device is a wireless router.

25. A removable storage device comprising:
an interface for transporting data to a first communications device; and
a module for storing configurations generated on a communication device.

26. The device of claim 25 wherein module is able to set the stored configurations on a second communication device.

27. The device of claim 25 wherein the settings are generated in order to establish a secure wireless network between the two communication devices.

28. The device of claim 26 wherein the interface is a USB dongle.

29. The device of claim 25 wherein the configuration settings are automatically generated through an auto run program on the device.

30. A system for transferring wireless network security data comprising:
a storage device;
a first communication device; and
a second communication device;
wherein the storage device receives information from the first communication device and transfers the data to the second communication.

31. The system of claim 30 wherein a secure wireless connection is established between the first and second communication device.

32. The system of claim 30 wherein the first communication device is a computing device.

33. The system of claim 30 wherein the second communication device is a wireless routing device.

34. The system of claim 30 wherein the first communication device is a wireless routing device.

35. The system of claim 30 wherein the second communication device is a computing device.
